(19) United States
(12) Patent Application Publication
(10) Pub. No.: US 2015/0029031 A1
(43) Pub. Date: Jan. 29, 2015

(54) DRIVER ALERTNESS DETECTION AND ALARM SYSTEM

(71) Applicant: Thomas Pank, Walkersville, MD (US)

(72) Inventor: Thomas Pank, Walkersville, MD (US)

(21) Appl. No.: 13/953,732

(22) Filed: Jul. 29, 2013

(51) Int. Cl. B60K 28/06; G08B 21/06

(52) U.S. Cl. CPC B60K 28/066; G08B 21/06
USPC 340/576

(57) ABSTRACT

An automated system which uses visual tracking technology to monitor the visual direction of a driver's sight, functions to keep the driver's eyes on the road to reduce the danger of potential distractions. When the driver is not looking at the road for a predetermined period, an audio queue, such as a beeping or alarm, will be utilized to bring the driver's attention back to the road. In addition, the system can limit the use of cell phones in the vehicle by disabling cell phones when the driver looks away from the road for greater than a preselected predetermined period. The period can be adjusted to allow for the answering of a hands free phone call, but preventing dialing and texts. The apparatus for alerting the driver includes an optical tracker, a receiver, a processor, and an audible alert device.

### CROSS-REFERENCE TO RELATED APPLICATIONS

This application claims priority to provisional application No. 61/677,183, filed Jul. 30, 2012.

### BACKGROUND OF THE INVENTION

The present invention generally relates to an automated system for automobile driver alertness. More particularly, the present invention relates to an automated system for automobile driver alertness using optical tracking of the eyes of a driver to determine if the driver is distracted from driving.

Drivers are distracted by any number of things ranging from fatigue to cell phone use. These distractions can take the attention of the driver off of the task of driving and often divert the driver's visual attention from the road. When distracted by such things as a cell phone call, adjusting a radio or texting, a driver often is unaware of the amount of time that his eyes are not focused on the road. The numerous laws and regulations and public awareness campaigns are ineffective remedies for combating driver inattention.

Cell phone signal blocking devices that can disable a cell phone if it is in a vehicle that is in motion have been proposed to curtail the use of cellular phones by drivers. However these devices have the undesired consequence of preventing passenger cell phone use and can prevent the emergency use of cell phones. Proposals to block only certain phones belonging to the driver of the vehicle are ineffective when the vehicle is driven by someone else or when the driver is distracted by a passenger cell phone. These systems and are also easily defeated by a driver using the phone of a passenger. Cell signal blockers do not address the fundamental problem of driver distraction because they only address one potential cause and do so ineffectively.

The prior art lacks an effective system to ensure that the driver remains alert and free from as many distractions as possible, including cell phone usage, texting, dashboard distractions, and passenger interactions.

### BRIEF SUMMARY OF THE INVENTION

In order to keep the driver's eyes on the road, it is important to keep track of the driver's eyes in addition to limiting potential distractions. One or more of the embodiments of the present invention provide an automated system that tracks the visual direction of the eyes of the driver. When the driver is not looking at the road for a predetermined period, an audio queue, such as a beeping or alarm, will be utilized to bring the drivers attention back to the road. In a preferred embodiment the audio queue will be sent using the automobiles audio system. In an alternative preferred embodiment, the system will include its own separate audio alert device. In addition the system can use the vehicle's audio system as a primary alert and an independent audio system as a failsafe backup.

The driver alertness system of the present invention will also monitor and limit the use of cell phones in the vehicle. In one embodiment the cell phone is disabled when the driver looks away from the road for greater than a preselected predetermined period, allowing for the answering of a hands free phone call, but preventing dialing and texts. In another embodiment the driver is selected when the automobile is started and the cell phone connected to the system. This allows for voice and hands free calling but prevents the use of the phone while driving. All non-selected phone would remain free to normal operations.

### BRIEF DESCRIPTION OF THE DRAWINGS

FIG. 1 illustrates a Driver Alertness System according to an embodiment of the present invention.

### DETAILED DESCRIPTION OF THE INVENTION

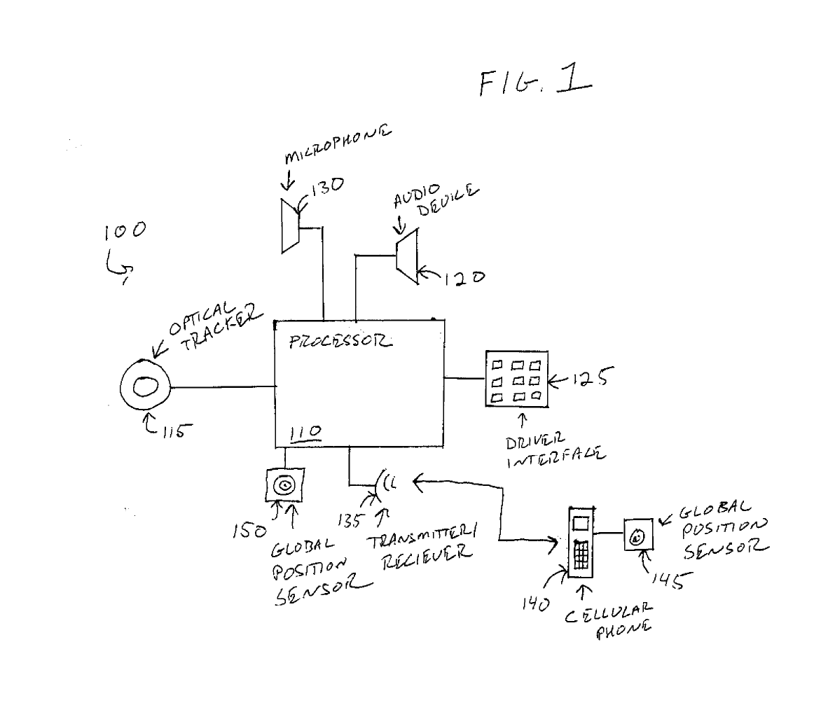

FIG. 1 illustrates a driver alertness system 100 according to an embodiment of the present invention. The Driver Alertness System 100 includes a Processor 110, an optical tracker 115, an audio device 120, a driver interface 125, a microphone 130, a global position sensor 150 and a Transmitter/receiver 135 for communication with a cellular phone 140. The cellular phone can optionally have its own global position sensor 145. The transmitter/receiver 135 can preferably be Blue Tooth compatible or any other format providing for exchange of data and information with the cellular telephone 140. The Driver alertness system 100 can also optionally have a vehicle interface 155 for connection to the vehicle to receive and/or exchange information with the vehicle. The vehicle interface can be wired or wireless and can also be Blue Tooth compatible if desired. The system and the vehicle can exchange and/or verify information such as information regarding the speed and location of the vehicle and the duration of the trip, road conditions, traffic conditions and vehicle conditions.

The processor 110, of the driver alertness system 100 controls the functioning of the system via its programing and is in data communication with the optical tracker 115 to monitor the vehicle driver. The processor 110 is also in data communication with the audio device 120 and with the microphone 120 for providing alert notifications and for receiving voice commands. The processor 110 is also in data communication with the driver interface 125 and the transmitter/receiver 135 to receive command inputs from the driver and information from the phone. The processor 110 is in data communication with the global position sensor 150 to monitor speed and location of the vehicle. The transmitter/receiver 135 is in data communication with the cellular phone 140 which receives location information from its global position sensor 145. The cellular phone 140 can also receive addition information such as traffic and weather conditions which can be transmitted to the processor 110, via the transmitter/receiver 135, for evaluation by the programing in the processor and used in determining the appropriate monitoring of the alertness of the driver.

In operation, the driver would enter the vehicle and using the driver interface 125 designate the device, e.g. cell phone 140, to be associated with that driver. Once the driver has input the device(s) the information is saved for future use. Alternatively, the transmitter/receiver 135 can detect the presence of a cell phone 140 and engage communications. In addition, the processor 110 may have the identification of several cell phones stored and be enabled to identify the connected cell phone 140 based upon a data ID. The processor 110 sends a signal to the transmitter/receiver 135 to establish communications with the cellular phone 140. The transmitter/receiver 135 sends and receives signals from the cellular phone 140 to establish communications.

The processor enables the driver monitoring function of its program in response to the detection of motion based upon information from either the vehicle's global position sensor 150 or the global position sensor of the cellular phone 145, or both. The detecting motion function can be set, for example, to engage the driver monitoring above a predetermined rate, such as 5 MPH.

When the processor 110 enables the program, the optical tracker 115 tracks the position of the driver's eyes in relationship to the road and sends this information to the processor 110. The optical tracker 115, can consist of one or more digital cameras and associated hardware and software to enable tracking of the vision focus of the driver. During initialization, a driver's attentive orientation is established. The processor 110 poles the optical tracker 115 at predetermined intervals to receive updates of the driver's visual orientation. The processor 110 compares the updated information to determine the driver's visual orientation.

When the processor 110 detects that the driver is not looking at the road for a predetermined period, for example 3 seconds, a signal is sent to the audio device 120, which may be the automobiles onboard speaker system or a speaker directly connected to the driver alertness system. The audio device 120 outputs a sound to alert the driver that they are no longer being attentive to the road. The sound may be a series of progressively louder beeps, an alarm or the like. In addition the processor 110 sends a signal through the transmitter/receiver 135 to the cellular phone 140 to disable all functions that utilize the user interface/buttons.

In another embodiment of the invention the processor disables the cellular phone 140 as soon as it has been connected to the processor 110. In this embodiment the driver may utilize the calling features of the cellular phone by using hands free or voice recognition. The driver would speak the name or number of the call recipient into the microphone 130. The processor 110 would use the cellular phone 140 to place the call.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. An apparatus for alerting a driver of a motor vehicle to avoid potentially hazardous behavior, comprising:
an optical tracker for detecting the visual orientation of said vehicle driver and for creating first visual orientation data indicative of said detected visual orientation;
a receiver for detecting the presence and activated state of a cell phone and for creating an activation signal indicative of detection of an active cell phone;
a processor connected to said optical tracker and said receiver for receiving said first visual orientation data and said activation signal and initiating a driver monitoring program in response; and for periodically polling said optical tracker to obtain updated visual orientation data; and for generating an alert signal upon determination of a deviation from a preferred visual orientation; and
an audible alert device for receiving said alert signal for providing an audible alert notification to said driver.
